(19) United States
(12) Patent Application Publication
(10) Pub. No.: US 2011/0243302 A1
(43) Pub. Date: Oct. 6, 2011

(54) RADIATION IMAGING SYSTEM AND METHOD

(75) Inventor: Dai MURAKOSHI, Kanagawa (JP)

(73) Assignee: FUJIFILM CORPORATION, Tokyo (JP)

(21) Appl. No.: 13/016,981

(22) Filed: Jan. 29, 2011

(30) Foreign Application Priority Data
Mar. 30, 2010 (JP) 2010-077164
Sep. 22, 2010 (JP) 2010-211863

(51) Int. Cl. G01N 23/04

(52) U.S. Cl. 378/62

(57) ABSTRACT

A radiation imaging system includes an X-ray source, first and second absorption gratins disposed in a path of X-rays emitted from the X-ray source, and an FPD. The second absorption grating is stepwise slid in an X direction relatively against the first absorption grating. Whenever the second absorption grating is slid, the FPD captures a fringe image and produces image data. A correction section corrects the image data for spatial variation of X-ray transmittance of the first and second absorption gratings. A phase contrast image generator produces a phase contrast image from the corrected image data. An X-ray absorption contrast image generator calculates a value related to an average of the corrected image data on a pixel-by-pixel basis, and produces an X-ray absorption contrast image from the value.

### BACKGROUND OF THE INVENTION

1. Field of the Invention

The present invention relates to a radiation imaging system and method that capture a phase contrast image of an object with the use of a diffraction grating.

2. Description Related to the Prior Art

X-rays are used as a probe for imaging inside of an object without incision, due to the characteristic that attenuation of the X-rays depends on the atomic number of an element constituting the object and its density and thickness. Radiography using the X-rays is widely available in fields of medical diagnosis, nondestructive inspection, and the like.

In a conventional X-ray imaging system for capturing a radiographic image of the object, the object to be examined is disposed between an X-ray source for emitting the X-rays and an X-ray image detector for detecting the X-rays. The X-rays emitted from the X-ray source are attenuated (absorbed) in accordance with the characteristics (atomic number, density, and thickness) of material of the object present in an X-ray path, and are then incident upon pixels of the X-ray image detector. Thus, the X-ray image detector detects an X-ray absorption contrast image of the object. There are some types of X-ray image detectors in widespread use, such as a combination of an X-ray intensifying screen and a film, an imaging plate containing photostimulable phosphor, and a flat panel detector (FPD) that consists of semiconductor circuits.

The smaller the atomic number of the element constituted of the material, the lower X-ray absorptivity the material has. Thus, the X-ray absorption contrast image of in vivo soft tissue, soft material, or the like cannot have sufficient image contrast. Taking a case of an arthrosis of a human body as an example, both of articular cartilage and its surrounding synovial fluid have water as a predominant ingredient, and little difference in the X-ray absorptivity therebetween. Thus, articular cartilage in the X-ray absorption contrast image of the arthrosis hardly has sufficient contrast with synovial fluid.

With this problem as a backdrop, X-ray phase imaging is actively researched in recent years. In the X-ray phase imaging, an image (hereinafter called phase contrast image) is represented based on a phase shift of the X-ray wave front passing through the object, which results in X-ray refraction, instead of intensity distribution of the X-rays having passed therethrough. It is generally known that when the X-rays are traversing the object, the phase of the X-ray wave front is much affected as compared with its amplitude. Accordingly, the X-ray phase contrast imaging, which exploits an X-ray phase shift, allows obtainment of the image with high contrast, even in the image of the object constituted of the materials that have little difference in the X-ray attenuation property. As a type of the X-ray phase contrast imaging system, X-ray Talbot interferometer, which is constituted of two transmission diffraction gratings, is proposed (refer to Japanese Patent Laid-Open Publication No. 2008-200359 and Applied Physics Letters, Vol. 81, No. 17, page 3287, written on October 2002 by C. David et al., for example).

The X-ray Talbot interferometer is constituted of the X-ray source, the X-ray image detector, and first and second diffraction gratings disposed between the X-ray source and the X-ray image detector. The first diffraction grating is disposed behind the object. The second diffraction grating is disposed downstream from the first diffraction grating by a specific distance (Talbot distance), which is determined from a grating pitch of the first diffraction grating and the wavelength of the X-rays. The Talbot distance is a distance at which the X-rays that have passed through the first diffraction grating form a self-image by the Talbot effect. If the object is disposed between the X-ray source and the first diffraction grating or between the first diffraction grating and the position where a self-image is generated (in this case, the Talbot distance), this self-image is spatially modulated according to the interaction (phase shifts) between the X-rays and the object.

In the X-ray Talbot interferometer proposed above, since the second diffraction grating is positioned at the Talbot distance, the second diffraction grating is overlaid on the self-image of the first diffraction grating. Thus, the self-image that is subjected to intensity modulation by the second diffraction grating is obtained. From this self-image, an intensity modulation signal, which indicates a fringe image subjected to the spatial modulation by the interaction with the object, is obtained. Scanning this fringe image by a fringe scanning technique allows obtainment of the phase contrast image of the object.

In the fringe scanning technique adopted in this application, a plurality of images are captured, while the second diffraction grating is slid relatively against the first diffraction grating in a direction substantially parallel to a surface of the first diffraction grating and substantially orthogonal to a grating direction of the first diffraction grating at a scan pitch that corresponds with a length divided by several parts of a grating pitch. By this scanning operation, series data (hereinafter called intensity modulation signal) composed of pixel data the intensity of which is periodically changed on a pixel basis of the X-ray image detector is obtained. From a phase shift amount (a phase shift amount between the presence and the absence of the object) of this intensity modulation signal, a differential phase image (corresponding to angular distribution of the X-rays refracted by the object) is obtained. Furthermore, integration of the differential phase image along a fringe scanning direction allows obtainment of the phase contrast image. This fringe scanning technique is also adopted in an imaging system using laser light (refer to Applied Optics, Vol. 37, No. 26, page 6227, written on September 1998 by Hector Canabal et al.).

Furthermore, an X-ray imaging system is proposed that can capture both of the X-ray absorption contrast image and the phase contrast image together, on the occasion of taking the phase contrast image with the use of the first and second diffraction gratings (refer to United States Patent Application Publication No. 2010/0220834). In this X-ray imaging system, an addition or average value of the pixel data composing the intensity modulation signal is calculated on a pixel basis, to produce the X-ray absorption contrast image.

However, since the first and second diffraction gratings have fine structures with high aspect ratio, namely, the X-ray shield members and apertures are several μm in width and several tens of μm in thick in the direction of the X-ray path, it is very difficult to manufacture such gratings with sufficient accuracy. The variation in the width and the thickness of the X-ray shield members and apertures causes a spatial variation in the X-ray transmittance of the diffraction gratings, and adverse effects on the image quality of the X-ray absorption contrast image.

To solve this problem, it is conceivable to retract the first and second diffraction gratings from the X-ray path in capturing the X-ray absorption contrast image. However, this requires space and a mechanism to retract the first and second diffraction gratings, and results in increase in size and cost of the X-ray imaging system. Also, it is difficult to precisely restore the first and second diffraction gratings from retraction positions into the X-ray path. The restoration requires high degree of positional reproducibility.

### SUMMARY OF THE INVENTION

An object of the present invention is to remove the effects of transmittance variation of diffraction gratings in a radiation imaging system that produces an X-ray absorption contrast image from a fringe image formed by X-rays having passed through the diffraction gratings.

To achieve the above and other objects, a radiation imaging system according to the present invention includes a radiation source for emitting a radiation, a first grating, an intensity modulator, a radiation image detector, a correction section, a phase contrast image generator, and a radiation absorption contrast image generator. The first grating, through which the radiation passes, produces a first fringe image. The intensity modulator applying intensity modulation to the first fringe image, and produces a second fringe image in each of plural relative positions out of phase with one another with respect to a periodic pattern of the first fringe image. The radiation image detector detects the second fringe image and produces image data. The correction section corrects the image data for the individual characteristics, e.g. a spatial variation of the radiation transmittance in each of the first grating and the intensity modulator. The phase contrast image generator produces a phase contrast image of an object disposed between the radiation source and the first grating or between the first grating and the intensity modulator based on a plurality of the image data corrected by the correction section. The radiation absorption contrast image generator calculates from the plurality of the image data corrected by said correction section a value related to an average of the image data with respect to the relative position on a pixel-by-pixel basis, and produces a radiation absorption contrast image of the object based on the value.

The first grating may have plural first radiation shield members. Each of the first radiation shield members extends in a first direction orthogonal to a direction of an optical path of the radiation. The plural first radiation shield members are arranged in a second direction orthogonal to both of the direction of the optical path and the first direction with leaving a predetermined first aperture width. The intensity modulator may have plural second radiation shield members. Each of the second radiation shield members extends in the first direction. The plural second radiation shield members are arranged in the second direction with leaving a predetermined second aperture width. The correction section may correct the image data for a spatial variation of the radiation transmittance caused by a variation in a ratio between a width of the first radiation shield member and the first aperture width and in a ratio between a width of the second radiation shield member and the second aperture width.

The correction section may further correct the image data for the spatial variation of the radiation transmittance caused by a variation in a thickness of the first and second radiation shield members along the direction of the optical path.

The correction section may have a correction coefficient of each of the relative positions to correct for the individual characteristics of the first grating and the intensity modulator.

The correction section may calculate the correction coefficient from the plurality of the image data obtained in the absence of the object.

The correction coefficient may be calculated whenever radiation energy spectrum is changed.

The radiation energy spectrum preferably depends on at least one of parameters including a tube voltage, a material type and a thickness of an additional filter.

The correction coefficient may be calculated from the plurality of the image data that is corrected for a property of the radiation image detector.

It is preferable that the correction section corrects the plurality of the image data for the property of the radiation image detector, and then corrects for the individual characteristics of the first grating and the intensity modulator.

The radiation imaging system may further include a display for displaying the phase contrast image or an overlay image. The overlay image is formed by overlaying phase information extracted from the phase contrast image on the radiation absorption image.

The phase information may be a phase shift distribution.

The intensity modulator may include a second grating and a scan mechanism. The second grating has a periodic pattern in the same direction as the periodic pattern of the first fringe image. The scan mechanism slides one of the first and second gratings at a predetermined scan pitch.

Each of the first and second gratings may be an absorption grating, and the first grating projects on the second grating the first fringe image produced by passage of the radiation. Otherwise, a phase grating is also available for the first grating. The first fringe image is a self-image of the first grating produced by the Talbot effect. The first grating may project the self-image to the second grating.

The radiation image detector may have plural pixels. Each of the pixels includes a conversion layer for converting the radiation into an electric charge, and a charge collection electrode for collecting the electric charge converted by the conversion layer. The charge collection electrode has plural linear electrode groups. The plural linear electrode groups are arranged out of phase from one another so as to have a periodic pattern in the same direction as the periodic pattern of the first fringe image, and thus the charge collection electrode may be also available for the intensity modulator.

The radiation imaging system may further include a small angle scattering image generator. The small angle scattering image generator calculates from the plurality of the image data a value related to a deviation from a mean value with respect to the relative position on a pixel-by-pixel basis, and produces a small angle scattering image based on the value.

A radiation imaging method according to the present invention includes the steps of passing the radiation through the first grating and producing the first fringe image; applying intensity modulation to the first fringe image by the intensity modulator, and producing the second fringe image in each of plural relative positions out of phase with one another with respect to the periodic pattern of the first fringe image; detecting the second fringe image and producing the image data; correcting the image data for the individual characteristics of the first grating and the intensity modulator; producing the phase contrast image of the object disposed between the radiation source and the first grating or between the first grating and the intensity modulator based on the plurality of the corrected image data; and calculating from the plurality of the image data the value related to the average of the image data with respect to the relative position on a pixel-by-pixel basis, and producing the radiation absorption image of the object based on the value.

According to the present invention, the radiation imaging system can capture both of the phase contrast image and the X-ray absorption contrast image at the same time. Before the production of the X-ray absorption contrast image, the individual characteristics of the radiation transmittance of the diffraction gratings are corrected for. As a result, the image quality of the X-ray absorption contrast image is improved.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is a schematic view of an X-ray imaging system according to a first embodiment;

FIG. 2 is a schematic view of a flat panel detector;

FIG. 3 is a schematic side view of an X-ray source, an object, and an imaging unit, and shows an example of difference in an X-ray path between the presence and the absence of the object;

FIG. 4 is an explanatory view of a fringe scanning technique;

FIG. 5 is a graph of pixel data (intensity modulation signals) obtained by the fringe scanning technique;

FIG. 6 is a graph for explaining averages of the pixel data for use in production of an X-ray absorption contrast image;

FIG. 7 is a flowchart of a transmittance correction coefficient calculation procedure;

FIG. 8 is a flowchart of a capture procedure of a phase contrast image and an X-ray absorption contrast image;

FIG. 9 is a plan view of a monitor displaying the phase contrast image and the X-ray absorption contrast image on a tiled manner;

FIG. 10 is a plan view of the monitor displaying an overlay image in which the phase contrast image and the X-ray absorption contrast image are overlaid on each other;

FIG. 11 is a block diagram of an image processor having an overlay image generator;

FIG. 12 is a schematic view of an X-ray image detector according to a second embodiment;

FIG. 13 is a block diagram of an image processor according to a third embodiment; and

FIG. 14 is a graph showing an example of amplitude used in production of a small angle scattering image.

### DESCRIPTION OF THE PREFERRED EMBODIMENTS

### First Embodiment

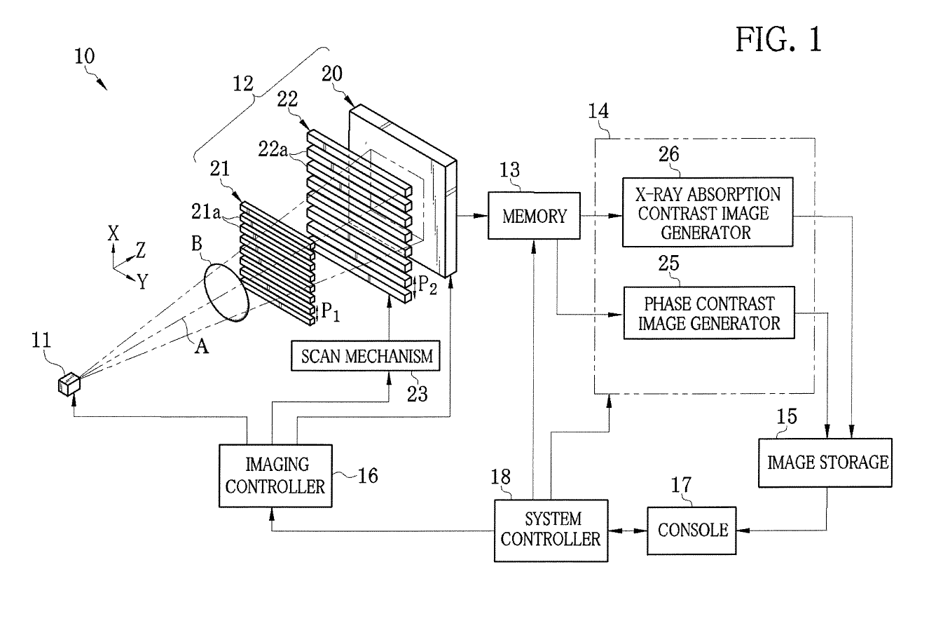

As shown in FIG. 1, an X-ray imaging system 10 according to a first embodiment is constituted of an X-ray source 11 for irradiating X-rays to an object B, an imaging unit 12 disposed so as to face the X-ray source 11, a memory 13, an image processor 14, an image storage 15, an imaging controller 16, a console 17 including an operation unit and a monitor, and a system controller 18. The imaging unit 12 detects the X-rays that have been emitted from the X-ray source 11 and passed through the object B, to produce image data. The memory 13 stores the image data outputted from the imaging unit 12. The image processor 14 produces a phase contrast image from plural frames of image data stored on the memory 13. The image storage 15 stores the phase contrast image produced by the image processor 14. The imaging controller 16 controls the X-ray source 11 and the imaging unit 12. The system controller 18 carries out centralized control of the entire X-ray imaging system 10 based on an operation signal inputted from the console 17.

The X-ray source 11 is constituted of a high voltage generator, an X-ray tube, a collimator (all of them are not illustrated), and the like, and irradiates the X-rays to the object B under control of the imaging controller 16. The X-ray tube is, for example, a rotating anode type X-ray tube. In the X-ray tube, an electron beam is emitted toward a target anode from a filament in accordance with a voltage generated by the high voltage generator, and collides with the target anode rotating at a predetermined speed to generate the X-rays. The target anode rotates for the purpose of reducing deterioration caused by the duration of the electron beam colliding with a fixed position of the anode. A collision portion by the electron beam is referred to as an X-ray focus from which the X-rays radiate. The collimator restricts an irradiation field of the X-rays emitted from the X-ray tube, so as to block part of the X-rays outside an examination region of the object B.

The imaging unit 12 includes a flat panel detector (FPD) 20 having semiconductor circuits, and first and second absorption gratings 21 and 22 that detect phase shifts of the X-ray wave front, caused by the interaction with the object B. The FPD 20 is disposed in such a position that a detection plane intersects at right angles with a direction (hereinafter called Z direction) along an optical axis A of the X-rays emitted from the X-ray source 11.

In the first absorption grating 21, a plurality of X-ray shield members 21a extending in a direction (hereinafter called Y direction) defined in a plane orthogonal to the Z direction are arranged in a direction (hereinafter called X direction) orthogonal to the Z and Y directions at a predetermined grating pitch P₁. In the second absorption grating 22, in a like manner, a plurality of X-ray shield members 22a extending in the Y direction are arranged in the X direction at a predetermined grating pitch P₂. The X-ray shield members 21a and 22a are preferably made of a material having high X-ray absorptivity, such as gold, platinum, lead, tungsten, and so on.

The imaging unit 12 is provided with a scan mechanism 23 that slides the second absorption grating 22 in a direction (X direction) orthogonal to a grating extending direction to vary the relative position between the first and second absorption gratings 21 and 22. The scan mechanism 23 is constituted of an actuator such as a piezoelectric element, for example. The scan mechanism 23 is driven under the control of the imaging controller 16 during fringe scanning described later on. Although details will be described later on, the memory 13 stores the image data obtained in each scan step of the fringe scanning by the imaging unit 12. Herein, the second absorption grating 22 and the scan mechanism 23 compose an intensity modulator.

The image processor 14 includes a phase contrast image generator 25 and an X-ray absorption contrast image generator 26. The phase contrast image generator 25 produces a differential phase image from the plural frames of image data, which are captured in each scan step of the fringe scanning by the imaging unit 12 and stored on the memory 13. Then, the phase contrast image generator 25 produces the phase contrast image by integration of the differential phase image along the X direction. The X-ray absorption contrast image generator 26 calculates from the plural frames of image data an average of the pixel data on a pixel-by-pixel basis. Then, the X-ray absorption contrast image generator 26 produces an X-ray absorption contrast image by the use of difference between the adjacent said averaged pixel data that detects the X-rays having passed through the object B as X-ray absorption contrast. The phase contrast image produced by the phase contrast image generator 25 and the X-ray absorption contrast image produced by the X-ray absorption contrast image generator 26 are recorded to the image storage 15, and then are outputted to the console 17 for display on a monitor 62.

The console 17 is provided with a monitor 62 and an input device (not illustrated) on which an imaging command and its settings are inputted. The input device includes, for example, a switch, a touch panel, a mouse, and a key board. Operation on the input device allows input of X-ray imaging conditions such as the X-ray tube voltage, tube current, X-ray exposure period and its intervals. The monitor 62 is a liquid crystal display or a CRT display, and displays information of the X-ray imaging conditions, the above phase contrast image, and the like.

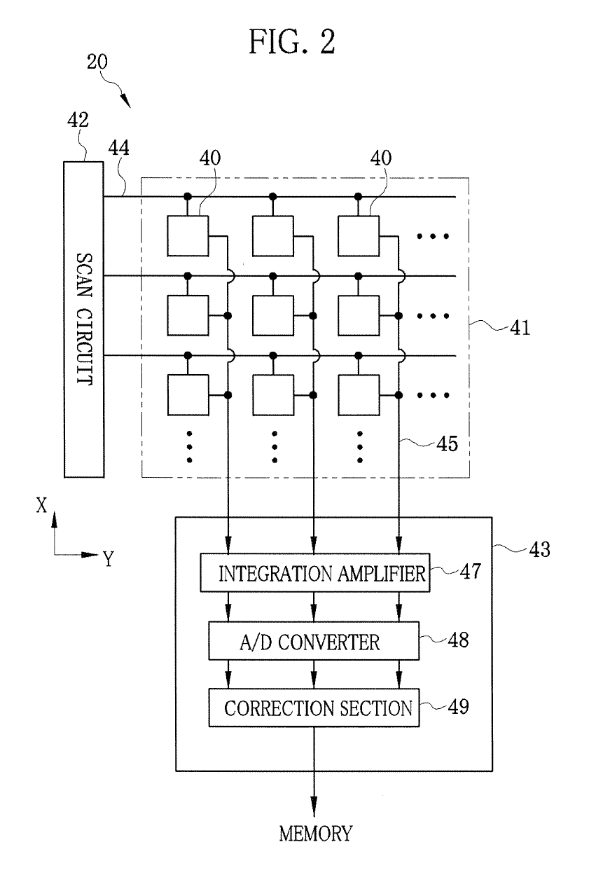

As shown in FIG. 2, the FPD 20 is constituted of an imaging section 41, a scan circuit 42, and a readout circuit 43. The imaging section 41 has a plurality of pixels 40 arranged in two dimensions along the X and Y directions on an active matrix substrate. Each of the pixels 40 converts the X-rays into an electric charge and accumulates the electric charge. The scan circuit 42 selects the row of the imaging section 41 the electric charges are to be readout, and controls readout timing. The readout circuit 43 reads out the electric charge accumulated in each pixel 40. Then, the readout circuit 43 converts the electric charges into the image data, and writes the image data to the memory 13. The scan circuit 42 is connected to every pixel 40 by scan lines 44 on a row basis. The readout circuit 43 is connected to every pixel 40 by signal lines 45 on a column basis. The pixels 40 are arranged at a pitch of approximately 100 μm in each of the X and Y directions.

Each pixel 40 is a direct conversion type X-ray detecting element, in which a conversion layer (not illustrated) made of amorphous selenium or the like directly converts the X-rays into the electric charge, and the converted electric charge is accumulated in a capacitor (not illustrated) that is connected to an electrode below the conversion layer. To each pixel 40, a TFT switch (not illustrated) is connected. To be more specific, a gate electrode of the TFT switch is connected to the scan line 44, and a source electrode thereof is connected to the capacitor, and a drain electrode thereof is connected to the signal line 45. Upon turning on the TFT switch by a drive pulse from the scan circuit 42, the electric charge accumulated in the capacitor is read out to the signal line 45.

Each pixel 40 may be an indirect conversion type X-ray detecting element, in which a scintillator (not illustrated) made of gadolinium oxide (Gd₂O₃), cesium iodide (CsI), or the like converts the X-rays into visible light, and a photodiode (not illustrated) converts the visible light into the electric charge. In this embodiment, the FPD based on a TFT panel is used as a radiation image detector, but various types of radiation image detectors based on a solid-state image sensor such as a CCD image sensor and a CMOS image sensor may be used instead.

The readout circuit 43 includes an integration amplifier 47, an A/D converter 48, and a correction section 49, and the like. The integration amplifier 47 integrates the electric charge outputted from each pixel 40 through the signal line 45, to convert the electric charge into a voltage signal (image signal). The A/D converter 48 converts the image signal produced by the integration amplifier 47 into digital image data. The correction section 49 applies corrections for detector properties and for the transmittance of the first and the second grating to the image data, and writes the corrected image data to the memory 13. The correction section 49 also produces correction coefficient tables, which are used in the correction described above.

The detector properties correction means correction of properties based on individual variability of the FPD 20, such as a dark signal, offset variation due to a residual image and a temperature drift, pixel sensitivity variation, and a defective pixel. The transmittance correction means correction of transmittance variation of the first and second absorption gratings 21 and 22, which is caused by variations in the grating pitches of the X-ray shield members 21a and 22a and variations in the thicknesses of the X-ray shield members 21a and 22a in the direction of the optical axis A. These corrections normalize the pixel data deviations over the valid image region, induced by the variation of the individual characteristics of the detector and gratings, and hence improve image quality of the phase contrast image and the X-ray absorption contrast image.

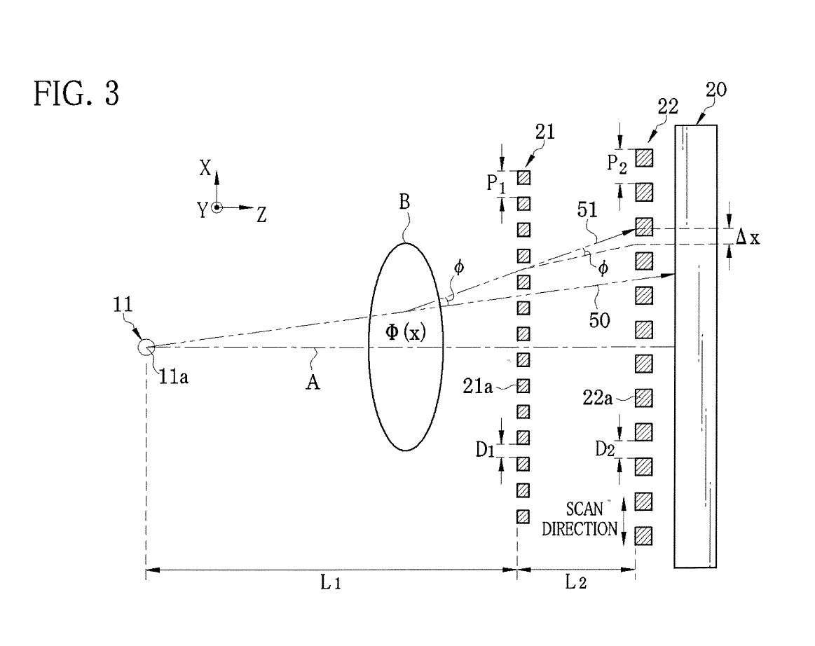

In FIG. 3, the X-ray shield members 21a of the first absorption grating 21 are arranged in the X direction at the predetermined grating pitch P₁ and at a predetermined spacing distance D₁ apart from one another. The X-ray shield members 22a of the second absorption grating 22 are arranged in the X direction at the predetermined grating pitch P₂ and at a predetermined spacing distance D₂ apart from one another. The X-ray shield members 21a are arranged on an X-ray transparent substrate (for example, a glass substrate; not illustrated), and the X-ray shield members 22a are arrange on an X-ray transparent substrate (for example, a glass substrate; not illustrated), in a like manner. The first and second absorption gratings 21 and 22 mainly provide the incident X-rays with more intensity variation than phase variation. Thus, the first and second absorption gratings 21 and 22 are referred to as amplitude gratings. Slits (aperture regions of the spacing distances D₁ and D₂) may not be empty clearances, but may be filled with an X-ray low-absorbent material such as a polymer material and light metal.

Irrespective of the contribution of the Talbot effect, the first and second absorption gratings 21 and 22 are designed so as to geometrically project the X-rays having passed through the slits on. To be more specific, the spacing distances D₁ and D₂ are set sufficiently larger than a peak wavelength of the X-rays emitted from the X-ray source 11, so that the most of the X-ray fractions irradiated to the gratings are not diffracted practically, but pass therethrough straight ahead. In a case where tungsten is used as the target anode of the X-ray tube and at the tube voltage of 50 kV, for example, the peak wavelength of the X-rays is approximately 0.4 Å. In this case, if the spacing distances D₁ and D₂ are set at the order of 1 to 10 μm, most of the X-ray fractions are geometrically projected through the slits without diffraction. In this case, the grating pitches P₁ and P₂ are set at the order of 2 to 20 μm.

The X-rays are emitted divergently from the X-ray focus 11a, so-called “cone beam” X-rays are radiated from the X-ray source 11. Thus, a projective image (hereinafter called G1 image or fringe image) projected through the first absorption grating 21 is magnified in proportion to a distance from the X-ray focus 11a. The grating pitch P₂ and spacing distance D₂ of the second absorption grating 22 are designed so that the slits of the second absorption grating 22 substantially coincide with a periodic pattern of bright portions of the G1 image formed in the position of the second grating 22. In other words, the grating pitch P₂ and spacing distance D₂ of the second absorption grating 22 satisfy the following expressions (1) and (2):

$$\begin{matrix}{P}_{2} = \frac{{L}_{1} + {L}_{2}}{{L}_{1}} {P}_{1} & ( 1 ) \\ {D}_{2} = \frac{{L}_{1} + {L}_{2}}{{L}_{1}} {D}_{1} & ( 2 )\end{matrix}$$

Wherein, L₁ represents a length from the X-ray focus 11a to the first absorption grating 21, and L₂ represents a length from the first absorption grating 21 to the second absorption grating 22.

In the case of the Talbot interferometer, the length L₂ between the first and second absorption gratings 21 and 22 is restricted to a Talbot distance, which depends on the grating pitch of the first diffraction grating and the wavelength of the X-rays. According to the imaging unit 12 of this embodiment, however, since the incident X-rays are projected through the first absorption grating 21 without diffraction, the G1 image of the first absorption grating 21 is observable in any position behind the first absorption grating 21 in a geometrically similar manner. Thus, the length L₂ between the first and second absorption gratings 21 and 22 can be established irrespective of the Talbot distance.

Although the imaging unit 12 according to this embodiment does not compose the Talbot interferometer, as described above, the Talbot distance Z is represented by the following expression (3), if with the use of the coherent X-ray source, the pitch of the first absorption grating and the wavelength of the X-rays are set so as to produce diffraction of the X-rays by the first absorption grating 21 and the Talbot effect:

$$Z = m \frac{{P}_{1} {P}_{2}}{λ} \qquad ( 3 )$$

Wherein, λ represents the wavelength (peak wavelength) of the X-rays, and m represents a positive integer.

The expression (3) represents the Talbot distance when the X-rays emitted from the X-ray source 11 form the cone beam, and is known by Japanese Journal of Applied Physics, Vol. 47, No. 10, page 8077, written on October 2008 by Atsushi Momose et al.

In this embodiment, since the length L₂ can be established irrespective of the Talbot distance, as described above, the length L₂ is set shorter than the minimum Talbot distance Z defined at m=1, for the purpose of downsizing the imaging unit 12 in the Z direction. In other words, the length L₂ satisfies the following expression (4):

$${L}_{2} < \frac{{P}_{1} {P}_{2}}{λ} \qquad ( 4 )$$

To produce a periodic pattern image with high contrast, it is preferable that the X-ray shield members 21a and 22a completely absorb the X-rays. However, some of the X-rays pass through the X-ray shield members 21a and 22a without being absorbed, even with the use of the above material having high X-ray absorptivity (gold, platinum, lead, tungsten, or the like). For this reason, it is preferable to thicken each of the X-ray shield members 21a and 22a in the Z direction as much as possible. In a sense, it implies to increase an aspect ratio of each shield member 21a, 22a to increase X-ray shielding ability. For example, when the X-ray tube voltage is 50 kV, it is preferable to absorb 90% or more of the X-rays incident on the each of gratings. In this case, it is necessary that the thickness of each X-ray shield member 21a, 22a is 30 μm or more of a gold (Au) equivalent.

With the use of the first and second absorption gratings 21 and 22 having above structure, the FPD 20 captures a fringe image subjected to intensity modulation by superimposing the second absorption grating 22 on the G1 image of the first absorption grating 21. If the object B is disposed between the X-ray source 11 and the first absorption grating 21, the fringe image detected by the FPD 20 is phase-modulated by the object B. This modulation quantity is proportionate to deviation angles of the X-rays due to a refraction effect by the object B. Consequently, analysis of the fringe image detected by the FPD 20 allows production of the phase contrast image of the object B.

Next, a method for analyzing the fringe image will be described. FIG. 3 shows an example of the X-ray that is refracted according to phase shift distribution Φ(x) with respect to the X direction of the object B. A reference numeral 50 indicates a path of the X-ray that travels in a straight line in the absence of the object B. The X-ray traveling in this path 50 passes through the first and second absorption gratings 21 and 22, and is incident upon the FPD 20. A reference numeral 51, on the other hand, indicates a path of the X-ray that is refracted by the object B in the presence of the object B. The X-ray traveling in this path 51 passes through the first absorption grating 21, and then is blocked by the X-ray shield member 22a of the second absorption grating 22.

The phase shift distribution Φ(x) of the object B is represented by the following expression (5):

$$Φ ( x ) = \frac{2 π}{λ} \int [ 1 - n ( x , z ) ] d z \qquad ( 5 )$$

Wherein, n(x, z) represents refractive index distribution of the object B, and z represents a direction that the X-rays travel. For the sake of simplicity, a Y coordinate is omitted in the expression (5).

The G1 image projected from the first absorption grating 21 to the position of the second absorption grating 22 is displaced in the X direction by an amount based on a refraction angle φ due to the refraction of the X-ray by the object B. This displacement Δx by the refraction is approximately represented by the following expression (6), on condition that the refraction angle φ is sufficiently small:

Δx≈L₂φ (6)

The refraction angle φ is represented by the following expression (7), with the use of the wavelength λ of the X-ray and the phase shift distribution Φ(x) of the object B:

$$φ = \frac{λ}{2 π} \frac{\partial Φ ( x )}{\partial x} \qquad ( 7 )$$

As is obvious from the above expressions, the displacement Δx of the G1 image due to the refraction of the X-ray by the object B relates to the phase shift distribution Φ(x) of the object B. Furthermore, the displacement Δx relates to a phase shift ψ (shift in a phase of the intensity modulation signal of each pixel 40 between in the presence of the object B and in the absence of the object B) of the intensity modulation signal of each pixel 40 detected by the FPD 20, as is represented by the following expression (8):

$$ψ = \frac{2 π}{{P}_{2}} Δ x = \frac{2 π}{{P}_{2}} {L}_{2} φ \qquad ( 8 )$$

Thus, determination of the phase shift ψ of the intensity modulation signal of each pixel 40 leads to obtainment of the refraction angle φ by using the expression (8), and furthermore leads to obtainment of the differentiation of the phase shift distribution Φ(x) by using the expression (7). Integrating the differentiation with respect to x allows obtainment of the phase shift distribution Φ(x) of the object B, that is, production of the phase contrast image of the object B. In this embodiment, the above phase shift ψ is determined by a fringe scanning technique described below.

In the fringe scanning technique, the images are captured, while one of the first and second absorption gratings 21 and 22 is slid relatively against the other in a stepwise manner in the X direction. In other words, the image is captured, whenever changing a phase of a grating period of one of the first and second absorption gratins 21 and 22 against that of the other. In this embodiment, the scan mechanism 23 described above slides the second absorption grating 22. With the sliding of the second absorption grating 22, the moiré fringes move. When a sliding distance along the X direction reaches the single grating period (grating pitch P₂) of the second absorption grating 22 (in other words, when the phase shift of moiré fringes reaches 2π), the moiré fringes return to the original positions. The FPD 20 captures the fringe images, each time the second absorption grating 22 is slid at a scan pitch of an integer submultiple of the grating pitch P₂. Then, the intensity modulation signal of each pixel 40 is obtained from the captured plural fringe images. The phase contrast image generator 25 of the image processor 14 applies arithmetic processing to the intensity modulation signal, to obtain the phase shift ψ of the intensity modulation signal of each pixel 40. The two-dimensional distribution of the phase shift ψ corresponds to the differential phase image.

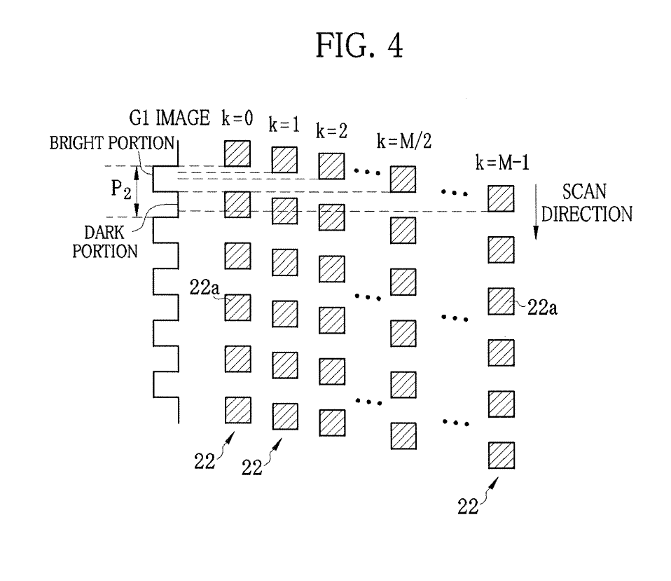

FIG. 4 schematically shows a state of shifting the second absorption grating 22 by a scan pitch of P₂/M, which the grating pitch P₂ is divided by M (integer of 2 or more). The scan mechanism 23 stepwise slides the second absorption grating 22 to each of an M number of scan positions represented by k=0, 1, 2, . . . , M−1. According to FIG. 4, an initial position of the second absorption grating 22 is defined as a position (k=0) in which the X-ray shield members 22a substantially coincide with dark portions of the G1 image formed in the position of the second absorption grating 22 in the absence of the object B. However, the initial position may be defined as any position out of k=0, 1, 2, . . . M−1.

In the position of k=0, the X-rays to be detected through the second absorption grating 22 include a component (non-refracted X-ray component) of the X-rays that have not been refracted by the object B, and a part of a component (refracted X-ray component) of the X-rays that have been refracted by the object B and passed through the first absorption grating 21. While the second absorption grating 22 is successively slid to k=1, 2, . . . , the non-refracted X-ray component is decreased and the refracted X-ray component is increased in the X-rays to be detected through the second absorption grating 22. Especially, in the position of k=M/2, substantially only the refracted X-ray component is detected through the second absorption grating 22. After the position of M/2, on the contrary, the refracted X-ray component is decreased and the non-refracted X-ray component is increased in the X-rays to be detected through the second absorption grating 22.

Since the FPD 20 captures the image in each of the positions of k=0, 1, 2, . . . , M−1, an M number of pixel data is obtained on each pixel 40. A method for calculating the phase shift ψ of the intensity modulation signal of each pixel 40 from the M number of pixel data will be hereinafter described. When the second absorption grating 22 is in the position k, the pixel data Iₖ(x) of each pixel 40 is represented by the following expression (9):

$${I}_{k} ( x ) = {A}_{0} + {\sum }_{n > 0} {A}_{n} exp [ 2 πi \frac{n}{{P}_{2}} \{ {L}_{2} φ ( x ) + \frac{{kP}_{2}}{M} \} ] \qquad ( 9 )$$

Wherein, x represents a coordinate of the pixel in the X direction, and A₀ represents the intensity of the incident X-rays, and Aₙ represents a value corresponding to the contrast of the intensity modulation signal (n is a positive integer). φ(x) corresponds to the above refraction angle φ represented as a function of the coordinate x of the pixel 40.

With the use of the following expression (10), the refraction angle φ(x) is represented by the following expression (11):

$$\begin{matrix}{\sum }_{k = 0}^{M - 1} exp ( - 2 πi \frac{k}{M} ) = 0 & ( 10 ) \\ φ ( x ) = \frac{{P}_{2}}{2 π {L}_{2}} arg [ {\sum }_{k = 0}^{M - 1} {I}_{k} ( x ) exp ( - 2 πi \frac{k}{M} ) ] & ( 11 )\end{matrix}$$

Wherein, “arg[ ]” means extraction of the argument, and corresponds to the phase shift ψ. Therefore, the determination of the phase shift ψ based on the expression (11) from the M number of pixel data (intensity modulation signals) obtained from each pixel 40 allows obtainment of the refraction angle φ(x) and the differentiation of the phase shift distribution Φ(x).

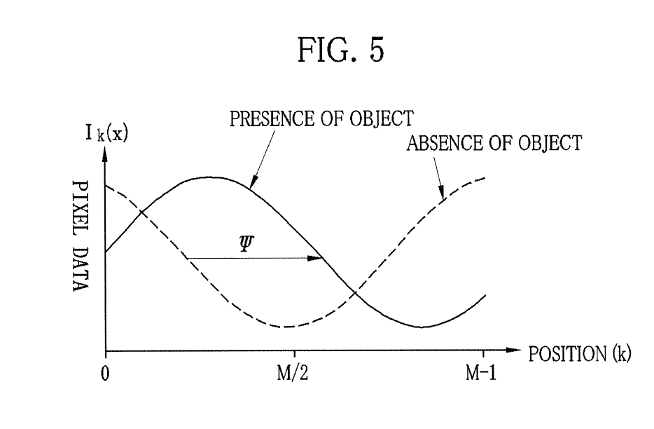

To be more specific, as shown in FIG. 5, the M number of pixel data obtained from each pixel 40 periodically varies with a period of the grating pitch P₂ with respect to the position k of the second absorption grating 22. In FIG. 5, a dashed line represents a plot of the pixel data in the absence of the object B, and a solid line represents a plot of the pixel data in the presence of the object B. The phase difference between waveforms of the plots corresponds to the above phase shift ψ.

Although the Y coordinate of each pixel 40 is not considered in the above description, carrying out similar calculations with respect to each Y coordinate allows obtainment of two-dimensional distribution ψ(x , y) of the phase shift over the X and Y directions. This two-dimensional distribution ψ(x, y) of the phase shift corresponds to the differential phase image. As is obvious from the above expressions (7) and (8), since the phase shift ψ is proportionate to the refraction angle φ, both of the phase shift ψ and the refraction angle φ are physical values proportionate to the differentiation of the phase shift distribution Φ(x).

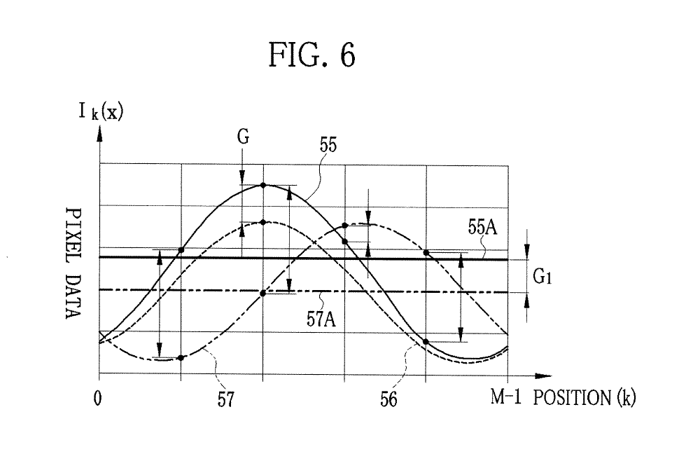

Next, how to produce the X-ray absorption contrast image by the image processor 14 will be described. As shown in FIG. 6, taking the sliding position k of the second absorption grating 22 in a horizontal axis of a graph, the M number of pixel data obtained in each pixel 40 of the FPD 20 is plotted on the graph and fitted to a sine wave to obtain the intensity modulation signal, which periodically varies with the period of the grating pitch P₂.

The intensity modulation signal 55 indicated by a sold line consists of the pixel data obtained in a margin portion of the imaging section 41 of the FPD 20, upon which the X-rays having not passed through the object B are incident. On the other hand, the intensity modulation signal 56 indicated by a dashed line consists of the pixel data obtained in a detection portion of the imaging section 41 of the FPD 20, upon which the X-rays having passed through the object B are incident. The amplitude of the intensity modulation signal 56 is smaller than the amplitude of the intensity modulation signal 55 by absorption of the X-rays by the object B. Since the intensity modulation signals 55 and 56 are in the same phase, it is easy to produce the X-ray absorption contrast image from the intensity modulation signals 55 and 56 by, for example, obtaining a maximum difference G of a pixel value as the X-ray absorption contrast.

However, in reality, since the X-rays that have passed through the object B are not only absorbed by the object B, but also are subjected to the intensity modulation due to the refraction by the object B according to the phase relation between the first and second absorption gratings 21 and 22, the phase of the intensity modulation signal is shifted, as is shown by the intensity modulation signal 57 indicated by a dashed two-dotted line. The intensity modulation signals 55 and 57 are out of phase with each other, so incorrect X-ray absorption contrast image in consideration of the X-ray absorption by the object B is produced, even if the difference in the pixel data is obtained in each position k of the second absorption grating 22 in the same manner described above.

Therefore, in this embodiment, the X-ray absorption contrast image generator 26 calculates an average of the intensity modulation signal of every pixel 40, and produces the X-ray absorption contrast image by the use of the average as a pixel value. Otherwise, the X-ray absorption contrast image generator 26 may calculate an average 55A of the intensity modulation signal 55 of the margin portion and an average 57A of the intensity modulation signal 57 of the detection portion, and produces the X-ray absorption contrast image by the use of a difference G1 between the averages 55A and 57A as the pixel value. Accordingly, it is possible to produce the correct X-ray absorption contrast image in proper consideration of the X-ray absorption by the object 13.

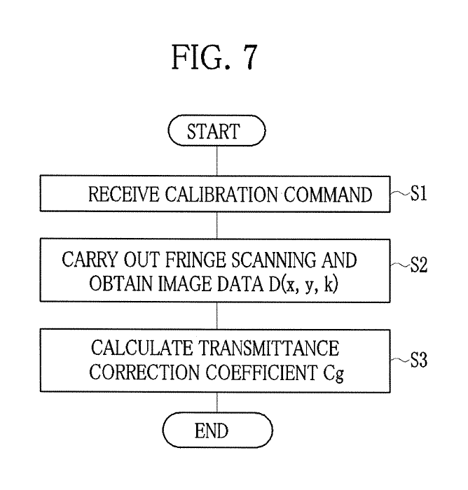

Next, how to obtain a transmittance correction coefficient for correcting the transmittance variation of the first and second absorption gratings 21 and 22 will be described. As shown in FIG. 7, the system controller 18 starts calculating the transmittance correction coefficient, upon receiving a command for calibration operation (S1). The calibration command is issued from the console 17 by an operator.

The system controller 18 commands the X-ray source 11 to emit the X-rays of predetermined radiation energy spectrum (the tube voltage, the material type and thickness of an additional filter) and predetermined dose in the absence of the object B. Then, the system controller 18 commands the imaging unit 12 to carryout fringe scanning with the slide of the second absorption grating 22, to obtain the pixel data D(x, y, k) in each scan position k (k=1 to M−1) (S2). In the pixel data D(x, y, k), x and y represent the coordinates of the pixel 40 of the FPD 20, and k represents the scan position of the second absorption grating 22.

Under the control of the system controller 18, the correction section 49 calculates based on the following expression (12) the transmittance correction coefficient Cg(x, y, k) of each scan position (S3), and stores the transmittance correction coefficient Cg(x, y, k).

$$Cg ( x , y , k ) = Cr \times \frac{1}{Dc ( x , y , k )} \qquad ( 12 )$$

In the expression (12), Cr represents a standardization coefficient established in accordance with an image bit scale to be handled. Dc may be the pixel data D(x, y, k) without detector properties correction, but is preferably the pixel data D(x, y, k) after being subjected to the detector properties correction.

As described above, the detector properties correction is to correct the properties based on individual variability of the FPD 20, such as the dark signal, the offset variation due to the residual image and the temperature drift, the pixel sensitivity variation, and the defective pixel. It is preferable that the pixel data D(x, y, k) is subjected to the detector properties correction on every item described above, but may be subjected thereto on part of the items. It is also preferable to obtain the transmittance correction coefficient Cg every radiation energy spectrum of the X-rays. The radiation energy spectrum of the X-rays depends on at least one of parameters including the tube voltage, the material type and thickness of the additional filter, and the like.

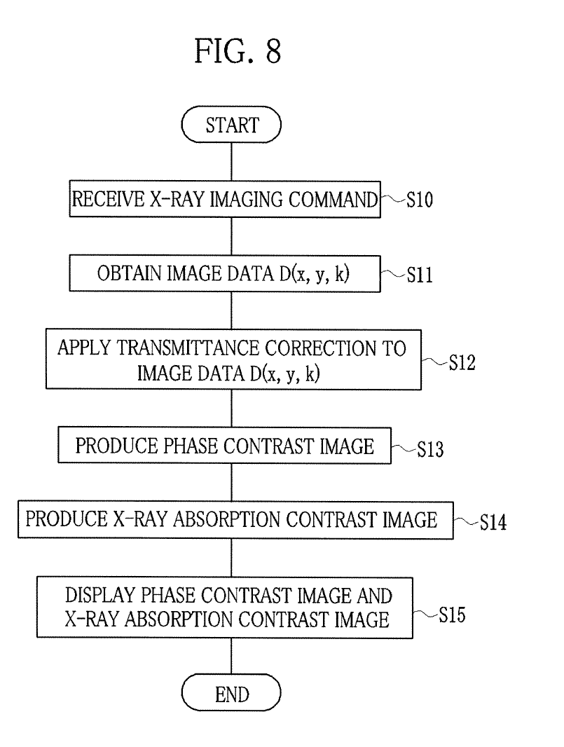

Next, a phase contrast image capture procedure with the use of the transmittance correction coefficient will be described with referring to a flowchart of FIG. 8. First, the object B is disposed between the X-ray source 11 and the imaging unit 12. When the operator issues an imaging command from the console 17 (S10), the system controller 18 commands the X-ray source 11 to emit the X-rays of the established or predetermined exposure condition, such as the tube voltage, the additional filter and the dose, and commands the imaging unit 12 to carry out fringe scanning with the slide of the second absorption grating 22 to obtain the pixel data D(x, y, k) in every scan position k (k=1 to M−1) (S11).

The correction section 49 applies the detector properties correction to the image data D(x, y, k) (S12), and outputs image data Dc′(x, y, k).

Then, the correction section 49 selects the appropriate transmittance correction coefficient Cg(x, y, k) according to the exposure condition, such as tube voltage and the material type and thickness of the additional filter, used in the exposure to the object B, and multiplies the image data Dc′(x, y, k) by the selected transmittance correction coefficient Cg(x, y, k) to obtain image data Dc″(x, y, k). In the image data Dc″(x, y, k), the transmittance variation in the first and second absorption gratings 21 and 22 is corrected. The image data Dc″(x, y, k) is written to the memory 13.

The phase contrast image generator 25 reads out the image data Dc″(x, y, k) from the memory 13, and produces the differential phase image on a pixel basis of the image data Dc″(x, y, k). Then, the phase contrast image generator 25 produces the phase contrast image by the integration of the differential phase image along the X direction (S13).

The X-ray absorption contrast image generator 26 reads out the image data Dc″(x, y, k) from the memory 13, and calculates the average of the intensity modulation signal on a pixel basis to produce the X-ray absorption contrast image (S14). To calculate the average of the intensity modulation signal, the pixel data may be simply averaged. However, if the number M of the scan positions of the second absorption grating 22 is small, the simple average of the pixel data includes a relatively large deviation error. Thus, after the pixel data is fitted to the sine wave, an average of the sine wave may be calculated. Instead of the average, a value corresponding to the average such as a summation may also be usable to produce the X-ray absorption contrast image.

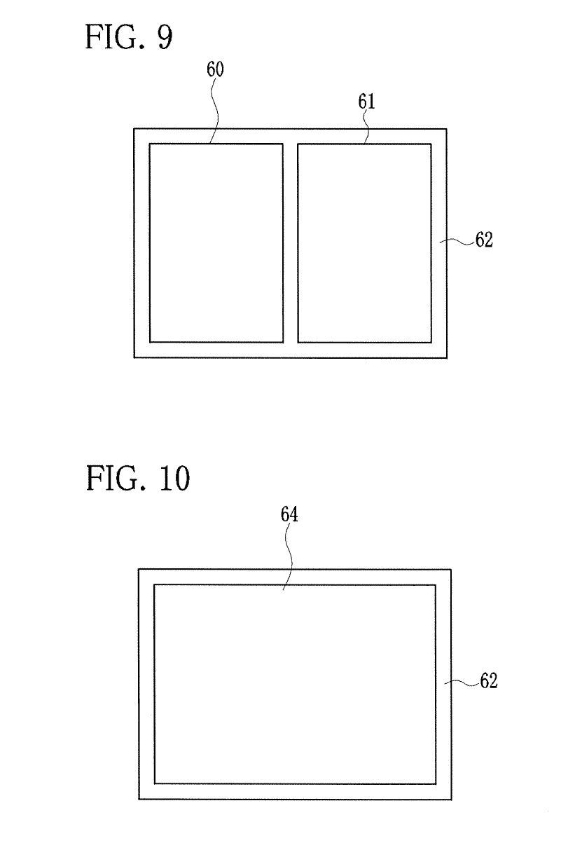

As shown in FIG. 9, the phase contrast image 60 and the X-ray absorption contrast image 61 are outputted to the console 17, and are displayed on the monitor 62 on a tiled manner. Otherwise, one of the phase contrast image 60 and the X-ray absorption contrast image 61 may be selectively displayed in response to switching operation from the console 17.

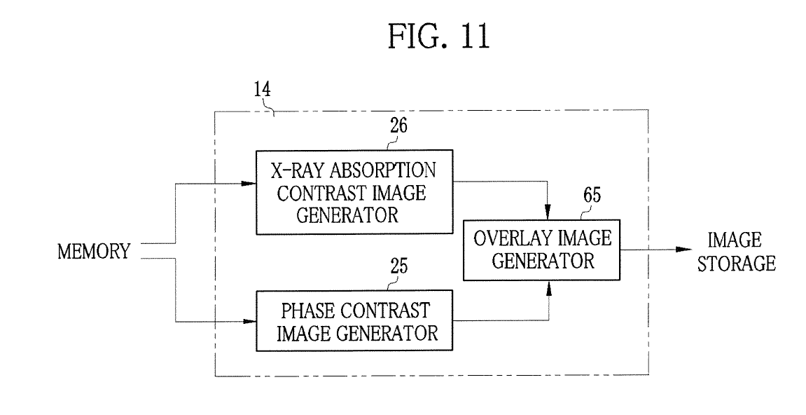

Otherwise, as shown in FIG. 10, the monitor 62 displays an overlay image 62 in which the phase contrast image and the X-ray absorption contrast image are overlaid on each other with some image procedure, such as weighting and filtering. In this case, as shown in FIG. 11, the image processor 14 is provided with an overlay image generator 65. The overlay image generator 65 applies edge processing and spatial frequency filtering to the phase contrast image, and overlays the appropriately weighted X-ray absorption contrast image on the phase contrast image. The overlay image 62 facilitates display of tissue with little absorption contrast that is hard to image in the X-ray absorption contrast image, e.g. soft tissue, in a single and natural image like a conventional simple X-ray image.

The phase contrast image on which the X-ray absorption contrast image is overlaid may be the phase contrast image itself produced by the phase contrast image generator 25, or may also be available phase information extracted from the phase contrast image, e.g. the phase shift distribution. Since the phase contrast image and the X-ray absorption contrast image are captured at the same time, there is no difference of the position of the object B between the phase contrast image and the X-ray absorption contrast image due to a motion of the object B or the like. Accordingly, it is not necessary to correct warping or miss-registration between the phase contrast image and the X-ray absorption contrast image in the overlay, and hence the image of high quality can be easily obtained.

In the above embodiment, if the distance from the object B to the FPD 20 is elongated, the G1 image is geometrically blurred corresponding to a size (0.1 mm to 1 mm, in general) of the X-ray focus 11a. The blur causes reduction in the image quality of the phase contrast image. For this reason, a multi-slit (source grating) may be disposed just behind the X-ray focus 11a.

The multi-slit is an absorption grating that is similar to the first and second absorption gratings 21 and 22. In the multi-slit, a plurality of X-ray shield members extending in one direction (Y direction in this embodiment) are periodically arranged in the same direction as that of the X-ray shield members 21a and 22a of the first and second absorption gratings 21 and 22 (X direction in this embodiment). This multi-slit partly blocks the X-rays emitted from the X-ray source 11 to reduce the effective focus size in the X direction, and forms a number of point sources arranged in the X direction, in order to prevent the blur of the G1 image.

In this embodiment, the first absorption grating 21 is projected to the image-plane, the second absorption grating 22 is arranged, by the X-rays that have passed through the slits of the grating geometrically. However, the first grating may diffract the incident X-rays and produce the so-called Talbot image on the image-plane (refer to International Publication No. WO2004/058070). In this case, the length L₂ between the first and second absorption gratings 21 and 22 has to be set at the Talbot distance. Also, in this case, a phase grating (phase diffraction grating) is available instead of the first absorption grating 21. This phase grating projects to the second absorption grating 22 the fringe image (self-image) produced by the Talbot effect.

In this embodiment, the object B is disposed between the X-ray source 11 and the first absorption grating 21. However, even if the object B is disposed between the first and second absorption gratings 21 and 22, the phase contrast image can be produced in a like manner.

### Second Embodiment

In the first embodiment, the second absorption grating 22 is provided separately from the FPD 20. However, the use of an X-ray image detector disclosed in U.S. Pat. No. 7,746,981 eliminates the provision of the second absorption grating 22. This X-ray image detector being a direct conversion X-ray image detector is provided with a conversion layer for converting the X-rays into electric charges and charge collection electrodes for collecting the electric charges converted by the conversion layer. In each pixel, the charge collection electrode includes plural linear electrodes arranged at a prescribed period. The plural linear electrodes are grouped and electrically connected to compose linear electrode groups. The linear electrode groups are laid out so as to be regularly out of phase with one another. The charge collection electrodes correspond to the intensity modulator.

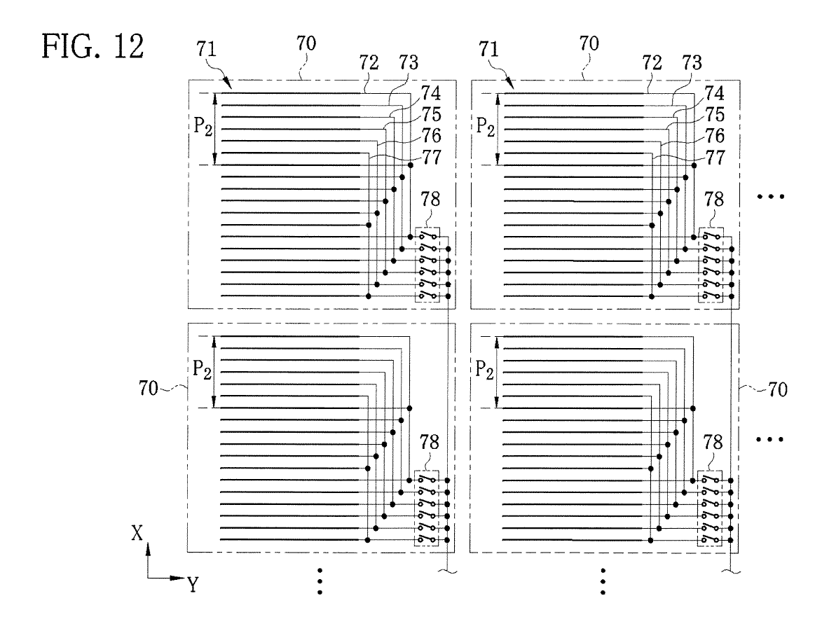

FIG. 12 shows a FPD according to this embodiment. In the FPD, pixels 70 are arranged in two dimensions along the X and Y directions at a constant arrangement pitch. In each of the pixels 70, a charge collection electrode 71 is formed to collect the electric charges converted by the conversion layer, which converts the X-rays into the electric charges. The charge collection electrode 71 includes first to sixth linear electrode groups 72 to 77. The first to sixth linear electrode groups 72 to 77 are arranged out of phase with one another by π/3. To be more specific, if the phase of the first linear electrode group 72 is determined to be zero, the phases of the second to sixth linear electrode groups 73 to 77 are set to be π/3, 2π/3, π, 4π/3, 5π/3, respectively. Each of the linear electrodes 72 to 77 extends in the Y direction in the pixel 70, and accumulates the electric charge.

Furthermore, the each pixel 70 is provided with a switch group 78 to read out the electric charges collected by the charge collection electrode 71. The switch group 78 includes TFT switches provided one by one for the one to sixth linear electrode groups 72 to 77. By controlling the switch group 78, the electric charges collected by the first to sixth linear electrode groups 72 to 77 are separately read out. Thus, it is possible to obtain the six types of image data corresponding to the six fringe images out of phase with one another in the single imaging operation, and to produce the phase contrast image based on the six image data with different phase with one another.

The use of the above X-ray image detector instead of the FPD 20 eliminates the need for provision of the second absorption grating 22 in the imaging unit 12, and hence brings about reduction in cost and size. Also, in this embodiment, since the plural types of image data that correspond to the plural fringe images subjected to the intensity modulation in the different phases can be obtained in the single imaging operation, it is possible to eliminate the need for mechanical scanning operation for the fringe scanning and provision of the scan mechanism 23 described above. Instead of the charge collection electrodes 71, other types of charge collection electrodes disclosed in the U.S. Pat. No. 7,746,981 are usable.

Furthermore, as another embodiment without the provision of the second absorption grating 22, the fringe image (G1 image) captured by the X-ray image detector may be periodically sampled in synchronization with change in the phase by signal processing, to add the intensity modulation to the fringe image.

### Third Embodiment

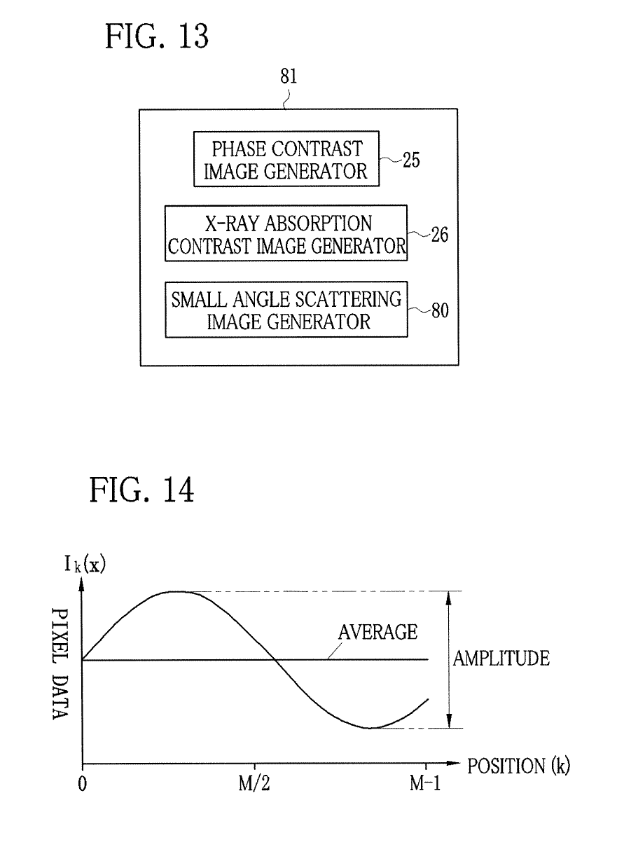

A small angle scattering image may be produced based on the plural images captured in the fringe scanning. To be more specific, as shown in FIG. 13, an image processor 81 according to a third embodiment is provided with the phase contrast image generator 25, the X-ray absorption contrast image generator 26, and a small angle scattering image generator 80. Any of the phase contrast image generator 25, the X-ray absorption contrast image generator 26, and the small angle scattering image generator 80 carries out arithmetic processing based on the image data obtained in each of the M number of scan positions of k=0, 1, 2, . . . , M−1. The phase contrast image generator 25 produces the phase contrast image, and the X-ray absorption contrast image generator 26 produces the X-ray absorption contrast image by the procedure described in the first embodiment.

As shown in FIG. 14, the small angle scattering image generator 80 calculates and images amplitude of the pixel data of each pixel, to produce the small angle scattering image. The amplitude may be calculated from the difference between a maximum value and a minimum value of the pixel data. However, if the number M of the scan positions of the second absorption grating 22 is small, the amplitude of the pixel data includes a relatively large deviation error. Thus, after the pixel data is fitted to the sine wave, the amplitude of the sine wave may be calculated. Instead of the amplitude, a value corresponding to deviation from a mean such as a variance value and standard deviation is available to produce the small angle scattering image.

The first embodiment is predicated on the use of the X-ray source 11 for emitting the X-rays of the cone beam, but may use an X-ray source for emitting parallel X-rays. In this case, the above expressions (1) to (4) are modified into the following expressions (13) to (16):

$$\begin{matrix}{P}_{2} = {P}_{1} & ( 13 ) \\ {D}_{2} = {D}_{1} & ( 14 ) \\ Z = m \frac{{P}_{1}^{2}}{λ} & ( 15 ) \\ {L}_{2} < \frac{{P}_{1}^{2}}{λ} & ( 16 )\end{matrix}$$

The present invention is applicable to various types of radiation imaging systems for medical diagnosis, industrial use, nondestructive inspection, and the like. As the radiation, gamma rays or the like are available other than the X-rays.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. A radiation imaging system comprising:
a radiation source for emitting a radiation;
a first grating for passing the radiation and producing a first fringe image;
an intensity modulator for applying intensity modulation to the first fringe image, and producing a second fringe image in each of plural relative positions out of phase with one another with respect to a periodic pattern of the first fringe image;
a radiation image detector for detecting the second fringe image and producing image data;
a correction section for correcting the image data for spatial variation of the first grating and an intensity modulator property;
a phase contrast image generator for producing a phase contrast image of an object disposed between the radiation source and the first grating or between the first grating and the intensity modulator based on a plurality of the image data corrected by the correction section; and
a radiation absorption contrast image generator for calculating from the plurality of the image data a value related to an average of the image data with respect to the relative position on a pixel-by-pixel basis, and producing a radiation absorption contrast image of the object based on the value.

2. The radiation imaging system according to claim 1, wherein
the first grating has plural first radiation shield members, and each of the first radiation shield members extends in a first direction orthogonal to a direction of an optical path of the radiation, and the plural first radiation shield members are arranged in a second direction orthogonal to both of the direction of the optical path and the first direction with leaving a predetermined first aperture width;
the intensity modulator has plural second radiation shield members, and each of the second radiation shield members extends in the first direction, and the plural second radiation shield members are arranged in the second direction with leaving a predetermined second aperture width; and
the correction section corrects the image data for a radiation transmittance variation caused by a variation in a ratio between a width of the first radiation shield member and the first aperture width and in a ratio between a width of the second radiation shield member and the second aperture width.

3. The radiation imaging system according to claim 2, wherein the correction section corrects the image data for the radiation transmittance variation caused by a variation in a thickness of the first and second radiation shield members along the direction of the optical path.

4. The radiation imaging system according to claim 1, wherein the correction section has a correction coefficient of each of the relative positions to correct for the spatial variation of the first grating and the intensity modulator property.

5. The radiation imaging system according to claim 4, wherein the correction section calculates the correction coefficient from the plurality of the image data obtained in an absence of the object.

6. The radiation imaging system according to claim 5, wherein the correction coefficient is held at every radiation energy spectrum.

7. The radiation imaging system according to claim 6, wherein the radiation energy spectrum with respect to at least one of parameters including a tube voltage, a material type and a thickness of an additional filter.

8. The radiation imaging system according to claim 5, wherein the correction coefficient is calculated from the plurality of the image data corrected for a property of the radiation image detector.

9. The radiation imaging system according to claim 8, wherein the correction section corrects the plurality of the image data for the property of the radiation image detector, and then corrects for the spatial variation of the first grating and the intensity modulator property.

10. The radiation imaging system according to claim 1, further comprising:
a display for displaying the phase contrast image or an overlay image, the overlay image being formed by overlaying phase information extracted from the phase contrast image on the radiation absorption contrast image.

11. The radiation imaging system according to claim 10, wherein the phase information is a phase shift distribution.

12. The radiation imaging system according to claim 1, wherein the intensity modulator includes:
a second grating having a periodic pattern in a same direction as the periodic pattern of the first fringe image; and
a scan mechanism for sliding one of the first and second gratings at a predetermined scan pitch.

13. The radiation imaging system according to claim 12, wherein each of the first and second gratings is an absorption grating, and the first grating projects to the second grating the first fringe image produced by passage of the radiation.

14. The radiation imaging system according to claim 12, wherein the first grating is a phase grating, and the first fringe image is a self-image of the first grating produced by a Talbot effect, and the first grating projects the self-image to the second grating.

15. The radiation imaging system according to claim 1, wherein
the radiation image detector has plural pixels, and each of the pixels includes a conversion layer for converting the radiation into an electric charge, and a charge collection electrode for collecting the electric charge converted by the conversion layer;
the charge collection electrode has plural linear electrode groups, and the plural linear electrode groups are arranged out of phase with one another so as to have a periodic pattern in a same direction as the periodic pattern of the first fringe image; and
the intensity modulator is the charge collection electrode.

16. The radiation imaging system according to claim 1, further comprising:
a small angle scattering image generator for calculating from the plurality of the image data a value related to a deviation of the image data from a mean with respect to the relative position on a pixel-by-pixel basis, and producing a small angle scattering image based on the value.

17. A radiation imaging method comprising the steps of:
passing a radiation through a first grating and producing a first fringe image;
applying intensity modulation to the first fringe image by an intensity modulator, and producing a second fringe image in each of plural relative positions out of phase with one another with respect to a periodic pattern of the first fringe image;
detecting the second fringe image and producing image data;
correcting the image data for spatial variation of the first grating and an intensity modulator property;
producing a phase contrast image of an object disposed between a radiation source and the first grating or between the first grating and the intensity modulator based on a plurality of the corrected image data; and
calculating from the plurality of the image data a value related to an average of the image data with respect to the relative position on a pixel-by-pixel basis, and producing a radiation absorption contrast image of the object based on the value.
